(19) United States
(12) Patent Application Publication
(10) Pub. No.: US 2012/0143638 A1
(43) Pub. Date: Jun. 7, 2012

(54) Making a Recurring Reservation for a Resource

(75) Inventors: Nancy Ellen Kho, Belmont, MA (US); Bill D. Le, Cedar Park, TX (US); Fang Lu, Billerica, MA (US); Alaa Abou Mahmoud, Dracut, MA (US)

(73) Assignee: INTERNATIONAL BUSINESS MACHINES CORPORATION, Armonk, NY (US)

(21) Appl. No.: 12/959,012

(22) Filed: Dec. 2, 2010

(51) Int. Cl. G06Q 10/00

(52) U.S. Cl. 705/5

(57) ABSTRACT

A method for making a recurring reservation for a resource, performed by a resource reservation processing system, the method includes, receiving a request for a recurring reservation of a type of resource, receiving a preference associated with the request, determining an availability of specific resources of the type of resource, displaying a proposed reservation of the specific resources based in part on the preference and the availability.

### BACKGROUND

Aspects of the present invention relate in general to resource reservation management, and more particularly, to methods and systems for making recurring reservations efficiently and in accordance with user preferences.

People often make use of systems that manage the reserving of available resources. For example, a company may have a reservation system in place for reserving resources such as conference rooms or teleconference lines. A person often needs to schedule a recurring reservation for a resource at a particular time. For example, a person may wish to reserve a particular conference room each Friday at 2:00 p.m. in the afternoon for a particular recurring meeting. The attendees of that meeting may have busy schedules and would prefer to meet at the same time each week. However, it may be the case that the particular conference room to be reserved is not available at the desired time each week. Consequently, some instances of the recurring reservation will have to reserve alternate conference rooms that may be available. This can be an inconvenience to the attendees as many people may become accustomed to a particular room or may not want to deal with the task of remembering which room was reserved at each instance of the recurring meeting.

### BRIEF SUMMARY

A method for making a recurring reservation for a resource, the method includes, with a physical computing system, receiving a request for a recurring reservation of a type of resource, with the physical computing system, receiving a preference for a manner of reserving the reservation, with the physical computing system, determining an availability of specific resources of the type of resource over a time range associated with the request, and with the physical computing system, displaying a proposed reservation of the specific resources based in part on the preference and the availability, the proposed reservation comprising an optimal reserving of alternate resources of the type of resource.

A resource reservation processing system includes a processor and a memory communicatively coupled to the processor. The processor is configured to receive a request for a recurring reservation of a type of resource, receive a preference for a manner of reserving the reservation, determine an availability of specific resources of the type of resource over a time range associated with the request, and display a proposed reservation of the specific resources based in part on the preference and the availability, the proposed reservation comprising an optimal reserving of alternate resources of the type of resource.

A computer program product for making a recurring reservation for a resource, the computer program product including a computer readable storage medium having computer readable code embodied therewith. The computer readable program code includes computer readable program code configured to receive a request for a recurring reservation of a type of resource, computer readable program code configured to receive a preference for a manner of reserving the reservation, computer readable program code configured to determine an availability specific resources of the type of resource over a time range associated with the request, and computer readable program code configured to display a proposed reservation of the specific resources based in part on the preference and the availability, the proposed reservation comprising an optimal reserving of alternate resources of the type of resource.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one embodiment of principles described herein.

FIG. 2 is a diagram showing an illustrative process for making a resource for a recurring reservation, according to one embodiment of principles described herein.

FIGS. 3A and 3B are diagrams showing illustrative displays of a proposed recurring reservation for a resource, according to one embodiment of principles described herein.

FIGS. 4A and 4B are diagrams showing an illustrative table (400) of a proposed recurring reservation for a resource, according to one embodiment of principles described herein.

FIGS. 5A and 5B are diagrams showing an illustrative defragmentation function for recurring reservations, according to one embodiment of principles described herein.

FIG. 6 is a flowchart showing an illustrative method for making a recurring reservation of a resource, according to one embodiment of principles described herein.

Throughout the drawings, identical reference numbers designate similar, but not necessarily identical, elements.

### DETAILED DESCRIPTION

The present specification discloses methods and systems for making recurring reservations for a resource in a manner that minimizes the need to reserve alternate resources. According to certain illustrative embodiments, a system receives a request for a recurring reservation for a type of resource from a user. The type of resource may be a conference room or a teleconference line. The system also receives a preference related to that request. The preference indicates the manner in which the recurring reservation should be made. For example, the user may indicate that he or she prefers the minimum number of alternate resources possible. Particularly, the user may wish to reserve as few different conference rooms as possible. Alternatively, the user may indicate that he or she prefers to maximize the number of instances which reserve the same resource even if this means that more alternative resources might be needed to do so. Particularly, the user may want to maximize the instances that reserve a specific conference room, even if doing so means reserving more different rooms for some instances of the recurring reservation.

The system can then determine a proposed reservation based on both the resources that are available and the user's preference. This proposed reservation schedule is then displayed to the user. The user can then choose whether or not to accept this proposed reservation and reserve the associated resources. In some cases, the system may then perform a defragmentation function on multiple recurring resources to optimize each recurring reservation according to its associated preference.

Through use of a method or system embodying principles described herein, a user can make a recurring reservation that reduces the need for reserving alternative resources. The user can also specify how he or she wants to reduce this reserving of alternative resources. More detail on how the user's preference will affect how the system reduces the reserving of alternate resources will be described in more detail below.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “type of resource” is to be broadly interpreted as a resource for which multiple variations or options exist. For example, if the type of resource is a conference room, there may be several different conference rooms available. The term “specific resource” is to be broadly interpreted as referning to a particular resource within a resource type. For example, a specific resource may be a specific conference room. An “alternate resource” refers to a different specific resource within the same type of resource. For example, an alternate resource may be a different conference room than then specific conference room being referenced, for example by the user's stated preference.

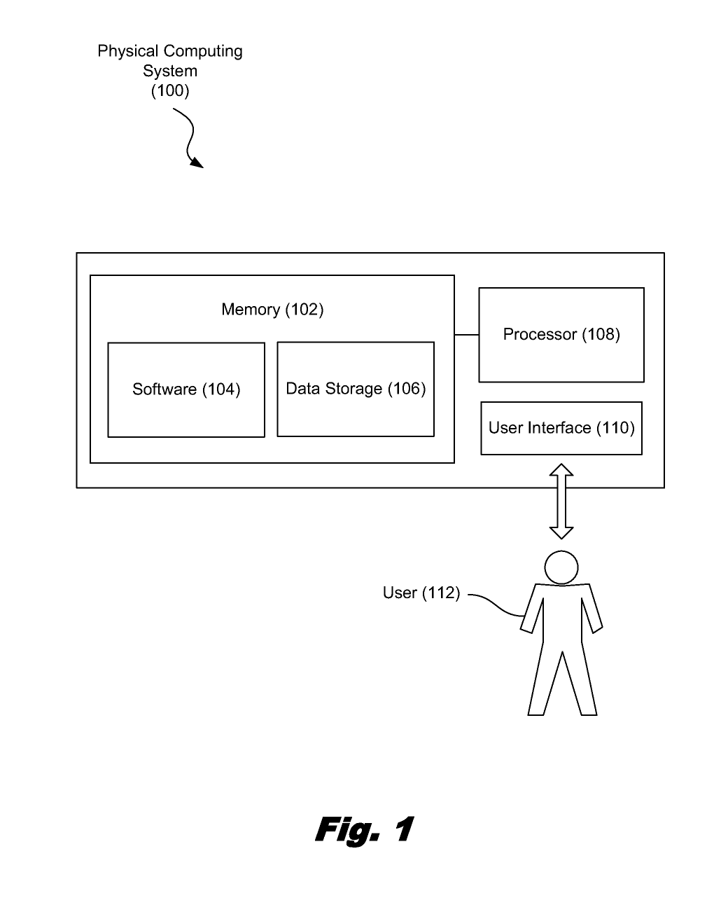

Referring now to the figures, FIG. 1 is a diagram showing an illustrative physical computing system (100) that may be used by a user to run applications. According to certain illustrative embodiments, the physical computing system (100) may include a memory (102) having software (104) and data (106) stored thereon. The software (104) may include computer readable instructions that cause the physical computing system (100) to manage and schedule recurring reservations.

There are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) in the memory (102). The physical computing system (100) may be embodied as a variety of physical computing devices including, but not limited to, a laptop or tablet computer, a desktop computer, and a mobile device such as a smart phone or a Personal Digital Assistant (PDA).

A user interface (110) may provide a means for the user (112) to interact with the computing system (100). The user interface may include any collection of devices for interfacing with a human user (112). For example, the user interface (110) may be a touch-screen device that acts both as a display and as an input.

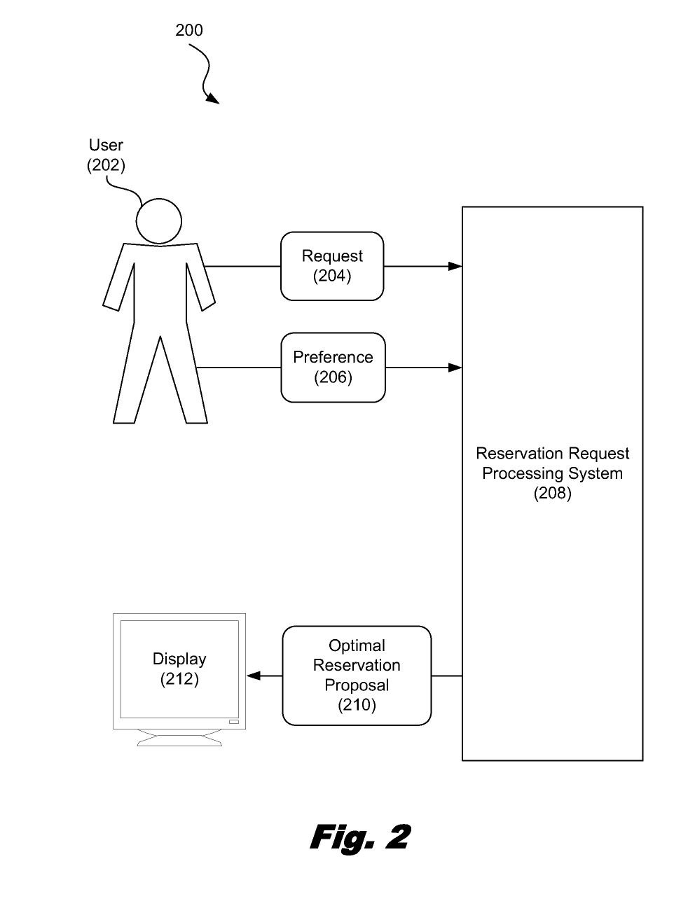

FIG. 2 is a diagram showing an illustrative process (200) for making a resource for a recurring reservation. According to certain illustrative examples, a user (202) sends a request (204) for a recurring reservation of a resource to a reservation request processing system (208). Additionally, the user (202) sends a preference (206) relating to that request. After determining the availability of the resources associated with the request and taking into account the preference (206) for one or more specific resources, the reservation request processing system (208) will submit a proposed reservation (210) to a display (212). The user may then view the proposed reservation (212) and decide whether or not to accept it.

A request (204) for a recurring reservation will typically include a time range as well as a time period between instances of the reservation. Specifically, a user may request to reserve a conference room for a specific time on a specific day of the week for a specific number of months. For example, a user may request to reserve a conference room for each Monday at 10:00 AM for the next two months.

When a user (202) submits a request (204) for a recurring reservation, he or she may not care which specific resource is reserved, but will be concerned that the same specific resource is reserved for each instance of the recurring reservation. For example, the user may not care which conference room is reserved, but he or she may wish to reserve the same specific conference room for each instance of the recurring reservation. Doing so can prevent the users of the conference room from having to check a schedule each week to determine which room has been reserved. However, it is not always the case that a particular conference room will be available for each instance of the reservation. Consequently, the user will then prefer to reduce the instances that require the reserving of an alternate resource such as a different conference room.

The preference (206) sent to the reservation request processing system (208) can inform the system (208) how to minimize the number of alternate resources. Specifically, a user may wish to maximize the number of instances that reserve the same specific resource, regardless of whether doing so may require the use of more alternate resources. For example, the user may wish to maximize the instances of the meeting occuring in a particular conference room, regardless of whether that may require instances that reserve two alternate conference rooms. Alternatively, the user may wish to minimize the number of alternate resources. For example, the user may prefer to only have to use one alternate conference room, even if doing so does not result in maximizing the reservation of a specific resource.

After the reservation request processing system (208) has checked the availability of the requested resource, the system (208) can provide a proposed reservation (208) to be displayed on a display device (212) to the user (202). This proposed reservation (208) is based on the resource that is requested, the availability of that resource and alternate resources, and the preference (206) provided by the user.

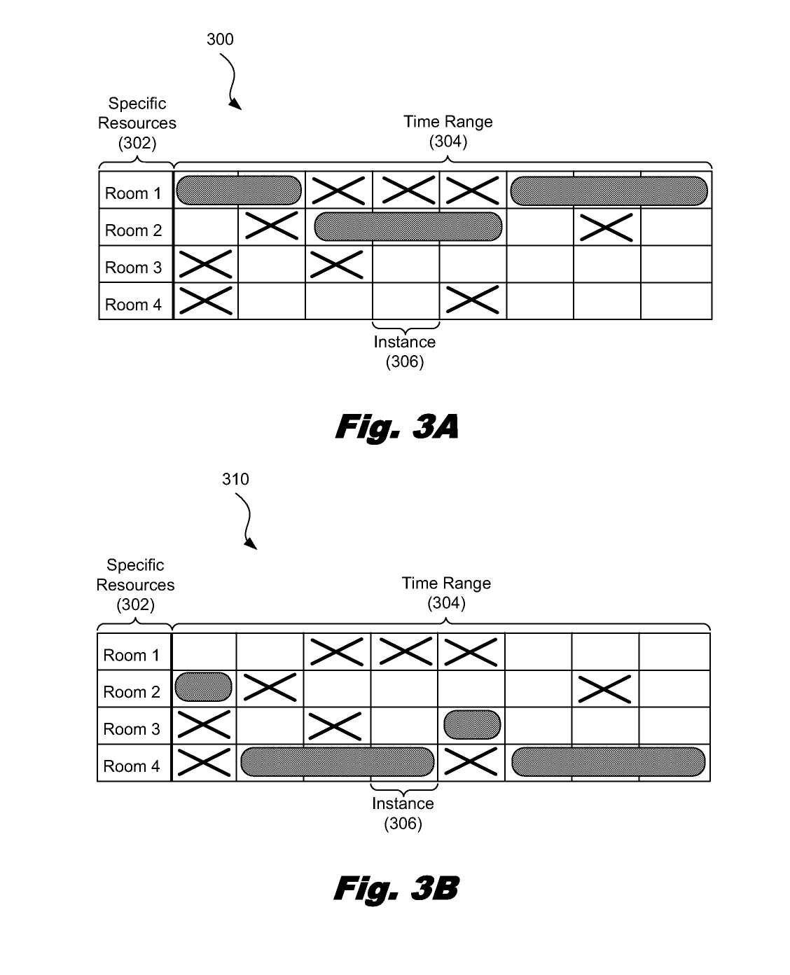

FIGS. 3A and 3B are diagrams showing illustrative displays of a proposed recurring reservation for a resource. FIG. 3A is a chart (300) showing an illustrative proposed reservation formed with a preference for reducing the total number of alternative resources reserved. The chart illustrates the availability of four specific resources (302) over a given time range (304). In this example, the resources are conference rooms. This particular time range includes 8 instances (306) of the recurring reservation. An ‘X’ indicates that a specific room is unavailable at the associated instance (306). The shaded regions indicate the proposed reservation at each instance (306).

With a preference to reduce the total number of alternative resources reserved, the resource reservation processing system (e.g. 208, FIG. 2) may provide a proposed schedule as illustrated in FIG. 3A. Specifically, five of the total eight instances are reserved with room 1 and 3 of the total eight instances are reserved with room 2. Thus, only one alternate resource is required.

FIG. 3B is a chart (310) illustrating a proposed recurring reservation with a preference for maximizing the use of one specific resource, regardless of whether doing so requires the need to reserve multiple additional resources. With this preference, six of the eight total instances are reserved with Room 4. Additionally, one instance is reserved with Room 2 and one instance is reserved with Room 3. Thus, although this recurring reservation has more instances reserved with the same specific resource than the recurring reservation illustrated in FIG. 3, doing so requires the reservation of a total of two alternate resources.

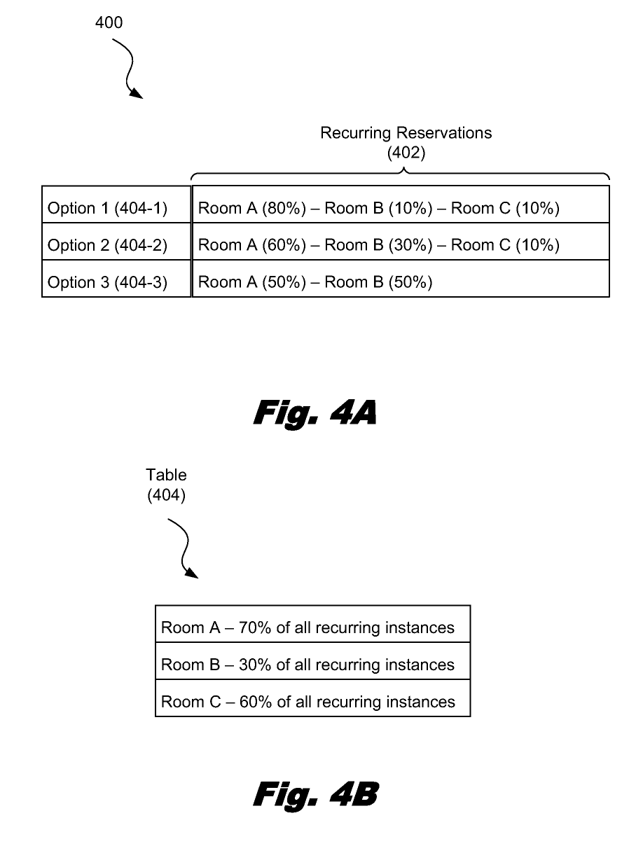

FIGS. 4A and 4B are diagrams showing an illustrative table (400) of a proposed recurring reservation for a resource. According to certain illustrative examples, the resource reservation processing system can display additional suggested recurring reservations and let the user choose which one to accept. The table (400) shows a number of proposed recurring reservations (402) based on the availability of the resources and a preference indicated by the user. The table displays to a user, the resources available and what percentage of the instances of the requested time range will be assigned to a particular specific resource.

In this example, the user provides the resource reservation processing system with the preference for maximizing the number of instances reserved with a specific resource option 1 (404-1) includes 80% of the instances being reserved with room A. 10% of the instances being reserved with room B, and 10% of the instances being reserved with room C. This option may be based on the preference for maximizing the number of instances reserved with a specific room. Option 2 (404-2) can display the next possible configuration based on that preference. Option 2 (404-2) includes 60% of the instances being resolved with room A, 30% of the instances being reserved with room B, and 10% of the instances being reserved with room C. Option 3 (402-3) includes 50% of the recurring reservations being reserved with room A and 50% of the instances being reserved with room B. The user might select option 3 (402-3) if he or she believes that, in light of the other options, it would be better to reduce the total number of alternate rooms.

FIG. 4B is a table showing a list of options provided to a user in response to a request for a recurring reservation. In some cases, a preference may indicate that the user wishes to have a few options displayed. For example, after requesting a recurring reservation of a conference room, the user may be provided with a table (404). In this example, the table indicates that Room A is available for 70% of the instances for the requested recurring reservation, Room B is available for 30% of the instances, and Room C is available for 60% of the instances. The user can then decide which option he or she prefers. In some cases, the user may wish to maximize the number of instances reserved to the same room. Thus, the user can select Room A. Alternatively, the user may be aware of certain features associated with Room C and decide that Room C would be a better option even if it is only available for 60% of the recurring instances.

According to certain illustrative embodiments, the resource reservation processing system may receive a number of requests for a recurring reservation within a given time window. The proposed recurring reservations for these requests may or may not have already been accepted by the users sending those requests. The resource reservation processing system may perform a defragmentation function on the reservations to rearrange the reservation schedule based on a preference.

For example, the defragmentation function may find the configuration that gives most of the requests their indicated preferences. If doing so causes a change in the reservations which have already been accepted, the users who made those reservations can be notified of the change in reservation.

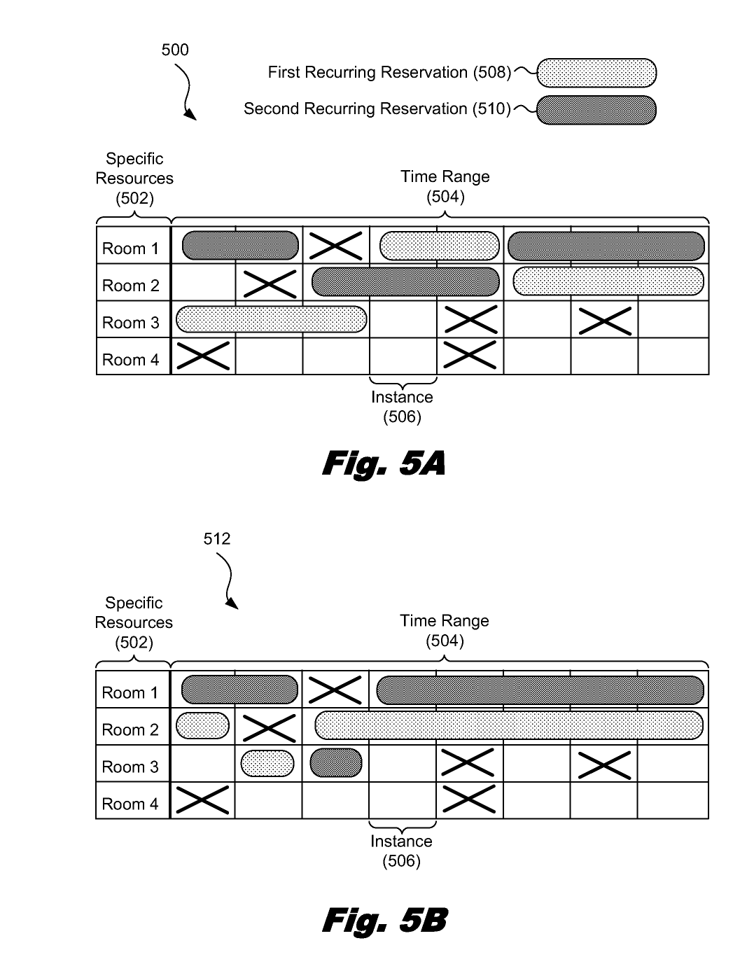

FIGS. 5A and 5B are diagrams showing an illustrative defragmentation function for recurring reservations. FIG. 5A is a chart (500) showing illustrative recurring reservations for a resource before a defragmentation function is applied. The chart (500) illustrates the reservation schedule of four specific resources (502) over a given time range (504). In this example, the resources are conference rooms. This particular time range includes 8 instances (506) of the recurring reservations. An ‘X’ indicates that a specific room is unavailable at the associated instance (306). The lightly shaded regions indicate a first recurring reservation (508) and the darker shaded regions indicate a second recurring reservation (510).

The first recurring reservation has instances scheduled for Room 1 and Room 2. Specifically, the first recurring reservation (508) has 5 non-consecutive instances reserved in Room 1 and 3 consecutive instances reserved in Room 2. The second recurring reservation (510) has instances reserved for Room 1, Room 2 and Room 3. Specifically, the second recurring reservation has three instances reserved for Room 3, two instances reserved for Room 1, and three instances reserved in Room 2.

FIG. 5B is a chart (512) showing the recurring reservations (508, 510) after a defragmentation function has been applied. According to certain illustrative examples, the defragmentation function can be configured to rearrange the schedule so that each recurring reservation (508, 510) is reserved for the maximum number of instances (506) in the same room. In this case, the defragmentation function has arranged the first recurring reservation so that seven non-consecutive instances are now reserved for Room 2 and one instance is reserved for Room 3. Additionally, the second recurring reservation (510) is now reserved in Room 1 for seven non-consecutive instances and one instance in Room 3.

The event that triggers application of the defragmentation function may vary. In some cases, the defragmentation function may be applied at regular intervals. For example, each night, the reservation management system may apply the defragmentation if there have been any changes to the reservations of any of the appropriate resources. These changes may be brought about by new requests and cancellations of requests. The defragmentation function may be applied to a specified time range, such as one year. In some cases, the defragmentation function can be applied manually by an administrator or manager.

The reservation management system may be given some constraints for the defragmentation process. For example, the number of instances that may be changed per requested reservation may be limited. This limits the changes a given user will have to make to his or her reservation schedule as a result of the defragmentation process. Additionally, some users may have immunity from the defragmentation process. For example, if a particular user having this immunity makes a recurring reservation, the defragmentation process will not make any changes to that user's reservation. In some cases, a user may have the privilege of making certain instances within a recurring reservation immune from the defragmentation process. This will allow a user to make important instances permanent.

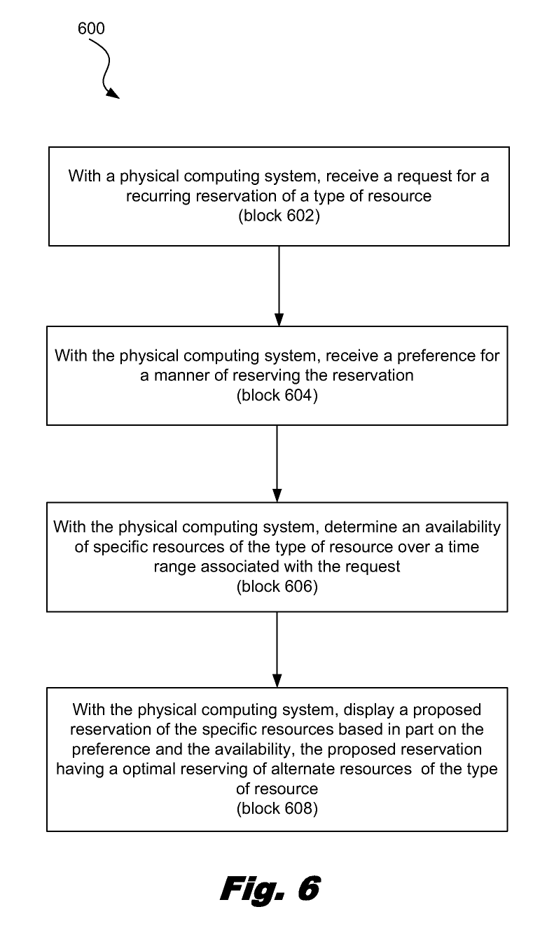

FIG. 6 is a flowchart showing an illustrative method (600) for making a recurring reservation of a resource. According to certain illustrative embodiments, the method includes, with a physical computing system, receiving (block 602) a request for a recurring reservation of a type of resource, with the physical computing system, receiving (block 604) a preference for a manner of reserving the reservation, with the physical computing system, determining (block 606) an availability of specific resources of the type of resource over a time range associated with the request, and with the physical computing system, displaying (block 608) a proposed reservation of the specific resources based in part on the preference and the availability, the proposed reservation comprising an optimal reserving of alternate resources of the type of resource.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for making a recurring reservation for a resource, the method comprising:
with a physical computing system, receiving a request for a recurring reservation of a type of resource;
with said physical computing system, receiving a preference associated with said request;
with said physical computing system, determining an availability of specific resources of said type of resource; and
with said physical computing system, displaying a proposed reservation of said specific resources based in part on said preference and said availability.

2. The method of claim 1, further comprising, displaying additional alternative proposed reservations for said resources based on said availability.

3. The method of claim 2, further comprising, receiving a request to accept one of said proposed reservations.

4. The method of claim 1, wherein said preference comprises reserving a same specific resource for as many instances as possible in meeting the request.

5. The method of claim 1, wherein said preference comprises reserving as few alternate resources of said type of resource as possible in meeting the request.

6. The method of claim 1, wherein said preference comprises reserving as many consecutive instances of a same specific resource of said type of resource as possible.

7. The method of claim 1, further comprising:
receiving additional requests for a recurring reservation for said type of resource;
receiving a preference associated with each of said requests; and
determining an proposed reservation for each of said requests based on respective said preferences.

8. A resource reservation processing system comprising:
a processor; and
a memory communicatively coupled to said processor;
in which said processor is configured to:
receive a request for a recurring reservation of a type of resource;
receive a preference associated with said request indicating how specific resources should be selected in meeting said request;
determine an availability specific resources of said type of resource for meeting said request; and
display a proposed reservation of said specific resources based at least in part on said preference and said availability.

9. The system of claim 8, wherein said processor is further configured to display additional alternative proposed reservations for said resources based on said availability.

10. The system of claim 9, wherein said processor is further configured to receive a request to accept one of said proposed reservations.

11. The system of claim 8, wherein said preference comprises reserving a same specific resource for filling as much of said request as possible.

12. The system of claim 8, wherein said preference comprises reserving a smallest number of specific resources as possible to fill said request.

13. The system of claim 8, wherein said preference comprises reserving as many consecutive instances of a same specific resource of said type of resource as possible to fill said request.

14. The system of claim 8, wherein said processor is further configured to:
receive additional requests for a recurring reservation for said type of resource;
receive a preference for each of said requests; and
determine a proposed reservation for each request based on said preferences.

15. A computer program product for making a recurring reservation for a resource, said computer program product comprising:
a computer readable storage medium having computer readable code embodied therewith, said computer readable program code comprising:
computer readable program code configured to receive a request for a recurring reservation of a type of resource;
computer readable program code configured to receive a preference associated with said request;
computer readable program code configured to determine an availability of specific resources of said type of resource for filling said request; and
computer readable program code configured to display a proposed reservation of said specific resources based on said preference and said availability.

16. The computer program product of claim 15, further comprising, computer readable program code configured to display additional alternative proposed reservations of said resources to meet the request based on said availability.

17. The computer program product of claim 15, wherein said preference comprises reserving a same specific resource to fill said request as much as possible.

18. The computer program product of claim 15, wherein said preference comprises reserving a smallest number of different resources to meet the request as possible.

19. The computer program product of claim 15, wherein said preference comprises reserving as many consecutive instances of a same specific resource of said type of resource as possible in filling the request.

20. The computer program product of claim 15, further comprising:
computer readable program code configured to receive additional requests for a recurring reservation for said type of resource;
computer readable program code configured to receive a preference for each of said requests; and
computer readable program code configured to determine a proposed reservation for each request based on said preferences.
